(19) United States
(12) Patent Application Publication
(10) Pub. No.: US 2015/0121224 A1
(43) Pub. Date: Apr. 30, 2015

(54) Method and System to Control a Seek Position of Multimedia Content Using a Rotatable Video Frame Graphic

(71) Applicant: AT&T Intellectual Property I, L.P., Atlanta, GA (US)

(72) Inventor: Leo Krasnahill, JR., Monroe TWP., NJ (US)

(73) Assignee: AT&T Intellectual Property I, L.P., Atlanta, GA (US)

(21) Appl. No.: 14/064,941

(22) Filed: Oct. 28, 2013

(51) Int. Cl. G06F 3/0484

(52) U.S. Cl. CPC G06F 3/0484
USPC 715/720

(57) ABSTRACT

A method includes initiating display of a rotatable video frame graphic at a display device. The rotatable video frame graphic enables seeking particular frames of multimedia content and includes a first representation associated with a first segment of the multimedia content and a second representation associated with a second segment of the multimedia content. The first representation is displayed in a first position and the second representation is displayed in a second position. The first position and the second position are arranged vertically with one position above the other position. The method further includes receiving a first input indicating a selection of a navigation control. The method also includes, in response to the first input, updating the rotatable video frame graphic to include a third representation associated with a third segment of the multimedia content and remove the first representation from the rotatable video frame graphic.

### FIELD OF THE DISCLOSURE

The present disclosure is generally related to controlling a seek position of multimedia content using a rotatable video frame graphic.

### BACKGROUND

Digital video recorder (DVR) devices enable a user to record multimedia content (e.g., a television program) and play the multimedia content back at a subsequent time. The DVR device may display frames of the multimedia content as a linear filmstrip of the multimedia content in response to receiving an input received from a remote control device (e.g., a request to seek-forward, seek-backward, skip-forward, skip-backward, or pause the multimedia content). The linear filmstrip may be displayed as a film strip where frames of the multimedia content are displayed side-by-side horizontally across a display (e.g., a television screen).

The linear filmstrip represents a horizontal time paradigm in which frames of the multimedia content advance through time from left to right. For example, each of the frames of the linear filmstrip may correspond to a one minute segment of the multimedia content. Thus, the user may use the remote control device to traverse the frames of the linear film strip to the right to fast forward the multimedia content, and the user may use the remote control device to traverse the frames of the linear film strip to the left to rewind the multimedia content. When the user selects (using the remote control device) a particular frame of the linear filmstrip, playback of the multimedia content resumes from a beginning of a segment of the multimedia content corresponding to the particular frame. Alternatively, the user may exit the linear filmstrip and playback of the multimedia content resumes at the playback location where the linear filmstrip was requested. The linear filmstrip may cover a large portion (e.g., over fifty percent) of the multimedia content presented at the display. Playback of the multimedia content is stopped each time a request to display the linear filmstrip is received due to the linear filmstrip's size.

### BRIEF DESCRIPTION OF THE DRAWINGS

FIG. 1 is a block diagram of a first illustrative embodiment of a system to control a seek position of multimedia content using a rotatable video frame graphic;

FIG. 2 is a block diagram of a second illustrative embodiment of a system to control a seek position of multimedia content using a rotatable video frame graphic;

FIG. 3A is a first illustrative animation sequence corresponding to a seek-forward operation of the rotatable video frame graphic of FIG. 1 or FIG. 2;

FIG. 3B is a second illustrative animation sequence corresponding to a seek-forward operation of the rotatable video frame graphic of FIG. 1 or FIG. 2;

FIG. 3C is a first illustrative animation sequence corresponding to a seek-backward operation of the rotatable video frame graphic of FIG. 1 or FIG. 2;

FIG. 3D is a second illustrative animation sequence corresponding to a seek-backward operation of the rotatable video frame graphic of FIG. 1 or FIG. 2;

FIG. 4 is a flowchart of a first method of controlling a seek position of multimedia content using a rotatable video frame graphic;

FIG. 5 is a flowchart of a second method of controlling a seek position of multimedia content using a rotatable video frame graphic; and

FIG. 6 is a block diagram of an illustrative embodiment of a computer system operable to support the various methods, systems, and computer readable media disclosed with respect to FIGS. 1-5.

### DETAILED DESCRIPTION

A rotatable video frame graphic may enable a user to perform seek operations for multimedia content (e.g., perform seek-forward or seek-backward operations) while covering a small portion of the multimedia content at a display device. The rotatable video frame graphic may display two (2) frames of the multimedia content at once and may be visually similar to a rotatable card index. The frames may be associated with segments of the multimedia content and may be sequentially organized within the rotatable frame graphic. When a user performs a seek-forward operation or a seek-backward operation, the frames rotate to display additional frames while hiding other frames. Thus, the rotatable video frame graphic resembles a rotatable card index where turning cards of the rotatable card index makes additional cards visible while hiding other cards. By resembling a rotatable card index, the rotatable video frame graphic gives an impression to a user of flipping through many linearly organized frames even though the rotatable video frame graphic may display as few as two (2) of the frames at a time. Because as few as two (2) of the frames are displayed at a time, the rotatable video frame graphic may enable a user to perform seek-forward and seek-backward operations while covering a small portion of the multimedia content during playback, enabling the rotatable video frame graphic to be displayed concurrently with the multimedia content at the display device.

In an exemplary embodiment, a method includes, at an electronic device, initiating display of a rotatable video frame graphic at a display device. The rotatable video frame graphic enables a user to seek particular frames of multimedia content. The rotatable video frame graphic includes a first representation associated with a first segment of the multimedia content and a second representation associated with a second segment of the multimedia content. The first representation is displayed in a first position and the second representation is displayed in a second position. The first position and the second position are arranged vertically with one position above the other position. The method further includes receiving a first input from an input device indicating a selection of a navigation control. The method also includes, in response to the first input, updating the rotatable video frame graphic to include a third representation associated with a third segment of the multimedia content and to remove the first representation from the rotatable video frame graphic.

In another exemplary embodiment, an apparatus includes a processor and a memory including instructions that, when executed by the processor, cause the processor to perform operations including initiating display of a rotatable video frame graphic at a display device. The rotatable video frame graphic enables a user to seek particular frames of multimedia content. The rotatable video frame graphic includes a first representation associated with a first segment of the multimedia content and a second representation associated with a second segment of the multimedia content. The first representation is displayed in a first position and the second representation is displayed in a second position. The first position and the second position are arranged vertically with one position above the other position. The operations further include receiving a first input from an input device indicating a selection of a navigation control. The operations also include, in response to the first input, updating the rotatable video frame graphic to include a third representation associated with a third segment of the multimedia content and to remove the first representation from the rotatable video frame graphic.

In another exemplary embodiment, a computer readable storage device stores instructions that, when executed by a processor, cause the processor to perform operations including initiating display of a rotatable video frame graphic at a display device. The rotatable video frame graphic enables a user to seek particular frames of multimedia content. The rotatable video frame graphic includes a first representation associated with a first segment of the multimedia content and a second representation associated with a second segment of the multimedia content. The first representation is displayed in a first position and the second representation is displayed in a second position. The first position and the second position are arranged vertically with one position above the other position. The operations further include receiving a first input from an input device indicating a selection of a navigation control of the remote control device. The operations also include, in response to the first input, updating the rotatable video frame graphic to include a third representation associated with a third segment of the multimedia content and to remove the first representation from the rotatable video frame graphic.

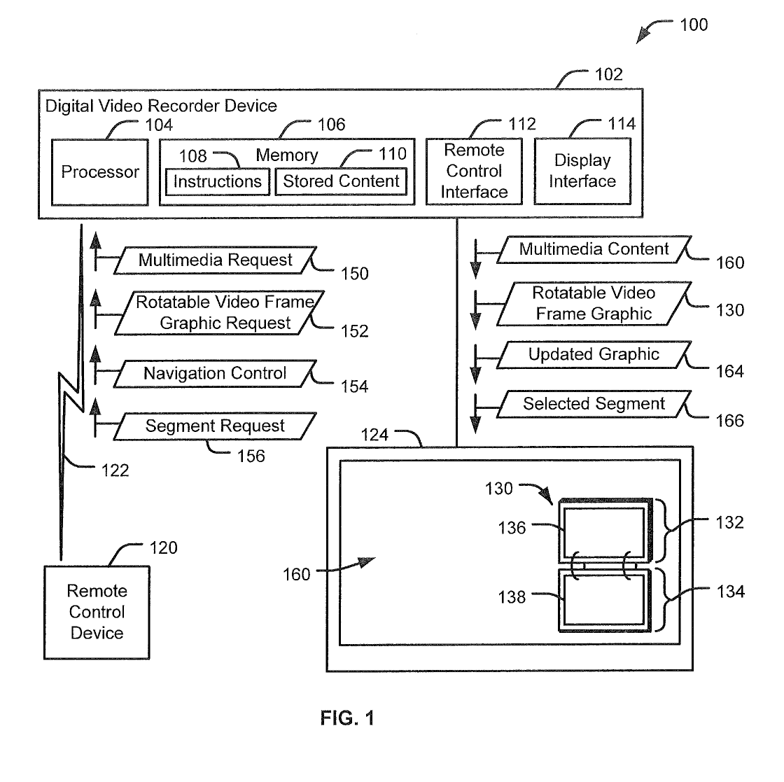

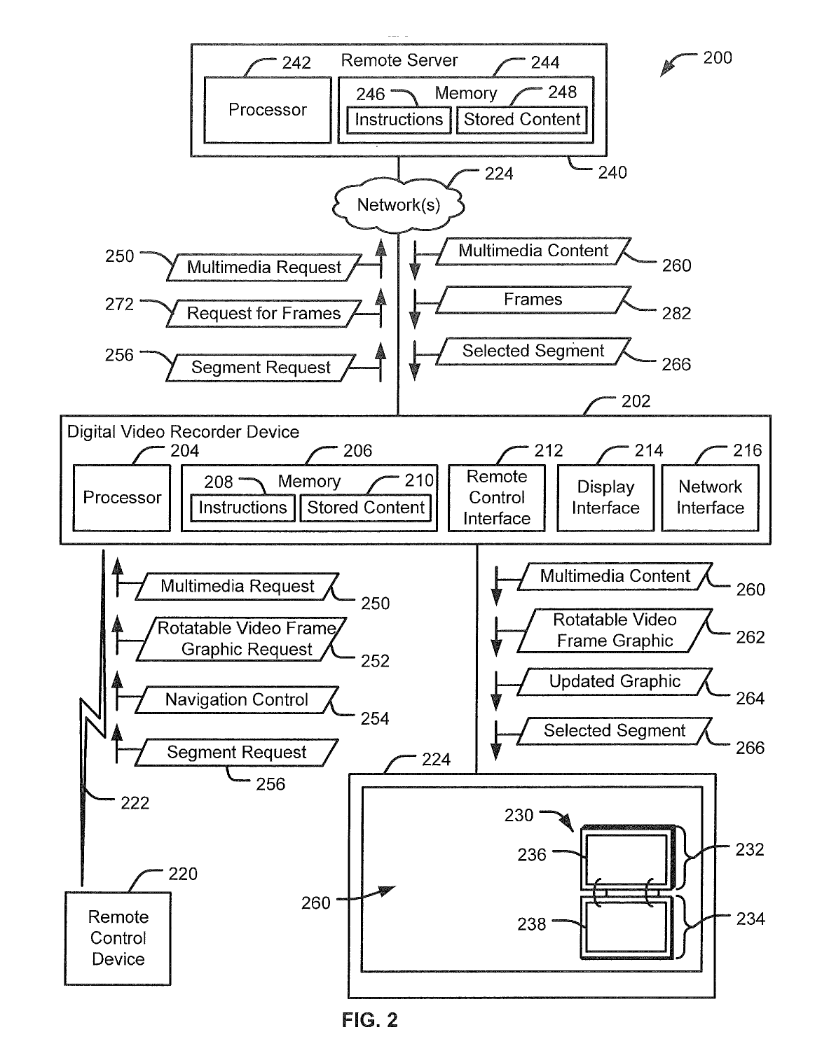

Referring to FIG. 1, an illustrative embodiment of a system 100 to control a seek position of multimedia content includes a digital video recorder (DVR) device 102. The system 100 further includes a remote control device 120 in communication with the DVR device 102. The system 100 also includes a display device 124 in communication with the DVR device 102. The system 100 enables a user to perform seek-forward operations and seek-backward operations using the remote control device 120 and the display device 124. For example, using the remote control device 120, the user may request to view a rotatable video frame graphic 130 at the display device 124. The limited size of the rotatable video frame graphic 130 (e.g., due to as few as two (2) frames being displayed) may enable the rotatable video frame graphic 130 to be displayed concurrently with multimedia content 160 at the display device 124. In one example, the multimedia content 160 corresponds to a recorded program (e.g., a television show, a movie, etc.) that is stored at the DVR device 102. The user may use the rotatable video frame graphic 130 to perform seek-forward and seek-backward operations without interrupting playback of the multimedia content 160 (e.g., without interrupting transmission of an audio/video stream corresponding to the multimedia content 160 from the DVR device 102 to the display device 124). In a particular illustrative embodiment, the DVR device 102 is incorporated into a set-top box device. Alternatively, the DVR device 102 may be a network device (e.g., a network DVR or other storage device) that is accessible to equipment at a customer premise (e.g., a set-top box device or a television) to view recorded programming, as further described with reference to FIG. 2.

In the illustrative embodiment of FIG. 1, the DVR device 102 includes a processor 104, a memory 106, a remote control interface 112, and a display interface 114. The processor 104 may include any type of processor capable of performing operations based on computer readable instructions. For example, suitable processors may include one or more microprocessors, digital signal processors, hardware implemented logic, or any combination thereof. The remote control interface 112 provides communication functions between the remote control device 120 and the DVR device 102. The remote control interface 112 may communicate with the remote control device 120 via a wired or a wireless connection 122. For example, the remote control interface 112 may communicate with the remote control device 120 via radio frequency signals, infrared signals, a wireless network, or any combination thereof. The display interface 114 provides communication functions between the display device 124 and the DVR device 102. The display interface 114 may communicate with the display device 124 via a wired connection, via a wireless connection, or any combination thereof. Although the remote control interface 112 and the display interface 114 are shown as individual blocks in FIG. 1, all or a portion of the remote control interface 112 and the display interface 114 may be incorporated into or integrated with the memory 106, the processor 104, or another component at the DVR device 102.

The memory 106 includes instructions 108 and stored content 110. The stored content 110 may include multimedia content recorded by the DVR device 102, multimedia content encoded and stored in a storage device (e.g., blu-ray disc, digital video disc, laser disk, magnetic tape, hard drive, etc.), multimedia content downloaded from another device, or any combination thereof. The instructions 108 may include computer readable instructions to enable the DVR device 102 to operate as further described herein. For example, the instructions 108 may include instructions and data structures to enable the processor 104 to initiate display of the rotatable video frame graphic 130 at the display device 124.

In operation, a user may send a multimedia request 150 to the DVR device 102 using the remote control device 120. For example, the multimedia request 150 may correspond to selection, by a user via the remote control device 120, of a “Play” button on a DVR interface displayed by the display device 124. In response to the multimedia request 150, the DVR device 102 may access the stored content 110 to retrieve multimedia content 160 and to initiate playback of the multimedia content 160 at the display device 124. The multimedia content 160 may correspond to a previously recorded program stored at the DVR device 102. During playback of the multimedia content 160 at the display device 124, the user may send a rotatable video frame graphic request 152 to the DVR device 102. The rotatable video frame graphic request 152 may correspond to selection of one or more buttons, options, or commands of the remote control device 120. For example, the rotatable video frame graphic request 152 may correspond to selection of a seek-forward (e.g., fast-forward) button, a seek-backward (e.g., rewind) button, a skip-forward button, a skip-backward button, a pause button, or another navigation button of the remote control device 120. In response to the rotatable video frame graphic request 152, the DVR device 102 may initiate display of the rotatable video frame graphic 130 by sending the rotatable video frame graphic 130 to the display device 124.

In a particular embodiment, the DVR device 102 dynamically generates and updates the rotatable video frame graphic 130 based on content stored at the DVR device 102 and/or based on content received from a network device, as further described with reference to FIG. 2. The rotatable video frame graphic 130 may include sequentially ordered frames corresponding to segments of the multimedia content with as few as two (2) frames visible at a time. For example, the rotatable video frame graphic 130 may include an upper position 132 and a lower position 134. The upper position 132 may include a first representation 136 (e.g., a first frame) corresponding to a first segment of the multimedia content 160. The lower position 134 may include a second representation 138 (e.g., a second frame) corresponding to a second segment of the multimedia content 160. In a particular embodiment, the first representation 136 and the second representation 138 correspond to reduced resolution versions of intra-coded frames (I-frames) of the multimedia content. The second segment may sequentially follow the first segment within the multimedia content 160.

Alternatively, the first segment may sequentially follow the second segment within the multimedia content 160. In order to give the impression of many sequentially ordered frames, the rotatable video frame graphic may resemble a rotatable card index, as shown in FIG. 1. A duration of each segment associated with a representation (e.g., the first representation 136 and the second representation 138) may correspond to a seek interval. For example, when the seek interval is ten seconds, a user may seek through the media content in ten second increments using the rotatable video frame graphic 130. Each representation of the rotatable video frame graphic 130 may correspond to a 5 second interval, a 10 second interval, a one minute interval, or any other interval of the multimedia content 160. In a particular exemplary embodiment, the DVR device 102 enables a user to customize the rotatable video frame graphic 130 by selecting the interval at the DVR device 102 using the remote control device 120.

In a particular embodiment, the remote control device 120 has one or more dedicated buttons that can be used to access and manipulate a rotatable video frame graphic 130 (e.g., a dedicated button to start and stop display of the rotatable video frame graphic 130). Alternatively, buttons that are used for other operations may also be used to manipulate the rotatable video frame graphic 130. For example, the DVR device 102 may support multiple types of seek operations. When a user holds down the fast-forward or rewind button on the remote control device 120, the DVR device 102 may perform conventional linear fast-forward or rewind operations. When the rotatable video frame graphic 130 is on-screen, the fast-forward and rewind buttons may be used to flip the cards of the graphic 130 forwards or backwards. Alternatively, other buttons of the remote control device 130 (e.g., channel up/down buttons or page up/down buttons) may be used to flip the cards. The described rotatable video frame graphic 130 may thus be used with a device-specific remote control device as well as a universal remote control device.

The rotatable video frame graphic 130 may be displayed at the display device 124 without interrupting playback of the multimedia content 160. For example, the DVR device 102 may send the multimedia content 160 and the rotatable video frame graphic 130 to the display device 124 concurrently. In a particular embodiment, sending the rotatable video frame graphic 130 and the multimedia content 160 to the display device includes sending frames of video (e.g., via a video output interface, such as a component interface or high-definition multimedia interface (HDMI)) that include the rotatable video frame graphic 130 overlaying a portion of the multimedia content 160. The rotatable video frame graphic 130 may be displayed in the lower right hand corner of the display device 124 as shown in FIG. 1, similar to a picture-in-picture frame. Alternatively, the rotatable video frame graphic 130 may be displayed at another position of the display device 124. In a particular illustrative embodiment, a user may configure the position of the rotatable video frame graphic 130 at the DVR device 102 using the remote control device 120. The rotatable video frame graphic 130 may be displayed in a small area (i.e., without covering a large portion of the multimedia content 160), thereby enabling a user to perform seek-forward and seek-backward operations without interrupting or obstructing a large portion of the multimedia content 160.

During playback of the multimedia content 160 and during display of the rotatable video frame graphic 130, a user may issue a navigation control 154 to the DVR device 102 using the remote control device 120. For example, the user may press a seek-forward button, a seek-backward button, a skip-forward button, a skip-backward button, a pause option, or another navigation button or command at the remote control device 120. In response to the navigation control 154, the DVR device 102 may update the rotatable video frame graphic 130. Updating the video frame graphic 130 may include rotating the ordered frames to make additional frames visible while hiding other visible frames. For example, updating the rotatable video frame graphic 130 may include adding a third representation corresponding to a third segment of the multimedia content, adding a fourth representation corresponding to a fourth segment, or both. Updating the rotatable video frame graphic 130 may also include removing the first representation 136, removing the second representation 134, or both. In the case that the navigation control 154 indicates a selection of a seek-forward option or a skip-forward option, the third segment and the fourth segment may be sequentially after the first segment and the second segment within the multimedia content 160. In the case that the navigation control 154 indicates a selection of a seek-backward or a skip-backward option, the third segment and the fourth segment may be sequentially before the first segment and the second segment within the multimedia content 160.

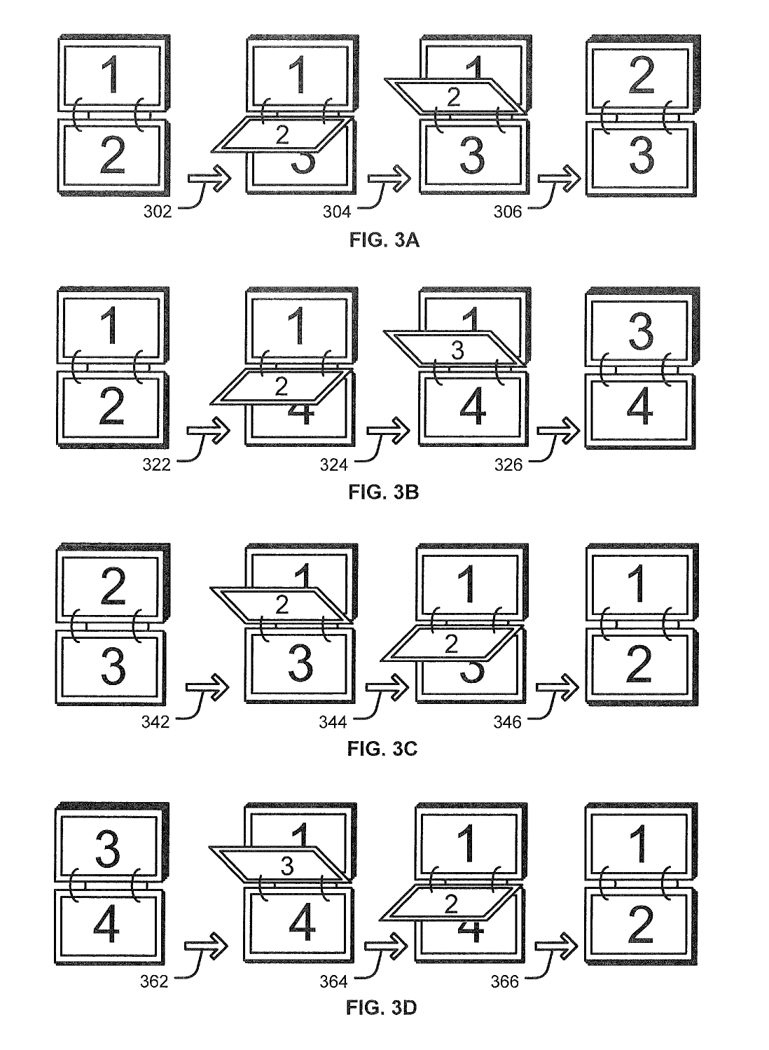

Updating the rotatable video frame graphic 130 may also include animating the rotatable video frame graphic 130 to resemble flipping through cards of a rotatable card index. For example, the DVR device 102 may continue to generate updated rotatable video frame graphics and send the updated rotatable video frame graphics to the display device while a user presses a seek-forward button or a seek-backward button at the remote control device 120. The continued updates may resemble cards rotatable to cover visible cards and to reveal additional cards. When the user releases the seek-forward button or the seek-backward button, the DVR device 102 may stop sending updated rotatable video frame graphics to the display device 124. Examples of card animation sequences are described further with reference to FIGS. 3A-3D. The DVR device 102 may update the rotatable video frame graphic 130 without interrupting playback of the multimedia content 160. For example, an updated video frame graphic 164 may be sent for display at the display device 124 concurrently with the multimedia content 160.

After the seek-forward operation or the seek-backward operation has been completed, the user may select a particular frame displayed at the rotatable video frame graphic to begin playback of a segment associated with the particular frame. For example, the user may use the remote control device 120 to send a segment request 156 to the DVR device 102 by pressing a “Select” button or an “Enter” button while a representation associated with the particular frame is selected (e.g., highlighted using a border or changed, coloring.) on the rotatable video frame graphic 130. The segment request 156 may indicate selection of a particular segment of the multimedia content 160 corresponding to a particular representation displayed at the rotatable video frame graphic 130 (e.g., the first representation 136, the second representation 138, the third representation, the fourth representation, or an additional representation). In response to the segment request 156, the DVR device 102 may cease playback of the multimedia content 160 and may initiate playback of the selected segment 166 of the multimedia content 160.

The low number of frames (e.g., two frames) displayed at the rotatable video frame graphic 130 and the concurrent transmission of the multimedia content 160 and the updated rotatable video frame graphic 164 enable a user to perform seek-forward operations and seek-backward operations (e.g., control a seek position) using the rotatable video frame graphic 130 without interrupting playback of multimedia content 160 at the display device 124. The resemblance of the rotatable video frame graphic 130 to a rotatable card index also gives the impression of flipping through many sequentially ordered frames even though a relatively low number of frames are displayed. Thus, the system 100 may increase the convenience of performing seek operations without interrupting playback of multimedia content, without obstructing a large portion of the multimedia content.

Referring to FIG. 2, another illustrative embodiment of a system 200 to control a seek position of multimedia content includes a DVR device 202. The system 200 further includes a remote control device 220 in communication with the DVR device 202 via a wired or wireless connection 222. The system 200 also includes a display device 224 (e.g., a television) in communication with the DVR device 202. The DVR device 202, the remote control device 220, and the display device 224 may correspond respectively to the DVR device 102, the remote control device 120, and the display device 124 of FIG. 1. The system 200 also includes a remote server 240 in communication with the DVR device 202 via a network 224. The remote server 240 may enable a user to perform seek-forward operations and seek-backward operations on multimedia content 260 streamed from the remote server 240. For example, the remote server 240 may send a first stream that includes the multimedia content 260 concurrently with a second stream that includes frames to be used in generating and updating a rotatable video frame graphic 230. Receiving the first stream and the second stream concurrently enables the DVR device 202 to initiate display of the rotatable video frame graphic 230 and to update the rotatable video frame graphic 230 without interrupting playback of the multimedia content 260 received from the remote server 240. In a particular illustrative embodiment, the DVR device 202 is incorporated into a set-top box device.

In the illustrative embodiment of FIG. 2, the DVR device 202 includes a processor 204, a memory 206, a remote control interface 212, and a display interface 214. The processor 204, the memory 206, the remote control interface 212, and the display interface 214 may correspond respectively to the processor 104, the memory 106, the remote control interface 112, and the display interface 114 of FIG. 1. The DVR device 202 may also include a network interface 216. The network interface 216 may enable the DVR device 202 to communicate with the remote server 240 via the network 224. The network 224 may include a local area network, a wireless local area network, a wide area network, the internet, another type of network, or any combination thereof. For example, the network 224 may include a public or private access network, such as an internet protocol television network, a video on demand network, a cable television network, a satellite television network, a fiber-optic television network, or any combination thereof. The memory 206 may include instructions 208 that, when executed by the processor 204, cause the processor 204 to perform operations as described herein. The memory 206 may also include stored content 210 (e.g., as one or more files). The stored content 210 may correspond to the stored content 110 of FIG. 1. Alternatively, the memory 206 may not include the stored content 210 and the DVR device 202 may be configured to receive multimedia content (e.g., the multimedia content 260) from the remote server 240 and to output the received multimedia content to the display device 224. In an illustrative embodiment, multimedia content that is received from the remote server 240 and that is not being recorded may be at least temporarily buffered before being output to the display device 224. Buffering such content may enable trick-play functionality (e.g., rewinding, fast-forwarding, pausing, etc.).

In the illustrative embodiment of FIG. 2, the remote server 240 includes a processor 242 and a memory 244. The processor 242 may include any type of processor capable of performing the operations of the remote server 240 as described herein. For example, the processor 242 may include one or more microprocessors, digital signal processors, hardware implemented logic, or any combination thereof.

The memory 244 includes instructions 246 and stored content 248. The stored content 248 may include multimedia content recorded at the remote server 240, multimedia content encoded and stored in a storage device (e.g., blu-ray disc, digital video disc, laser disk, magnetic tape, a hard disk, a solid state drive, etc.), multimedia content downloaded from another device, television content received at the remote server 240 from a television content provider, video on demand content, or any combination thereof. For example, the remoter server 240 may include a video on demand server of an internet protocol television network. The instructions 246 may include computer readable instructions to enable the remote server 240 to operate as described herein. For example, the instructions 246 may include instructions and data structures to enable the processor 242 (and/or a communication interface of the remote server 240) to stream multimedia content in a first stream to the DVR device 202 and to stream frames associated with segments of the multimedia content in a second stream to the DVR device 202.

In operation, a user may send a multimedia request 250 to the DVR device 202 using the remote control device 220. In response to the multimedia request 250, the DVR device 202 may forward the multimedia request 250 to the remote server 240 via the network 224. In response to the multimedia request 250, the remote server 240 may send the multimedia content 260 to the DVR device 202 via a first stream. The first stream may include a broadcast stream, a multicast stream, a unicast stream, or any combination thereof. In response to receiving the first stream, the DVR device 202 may initiate playback of the multimedia content 260 at the display device 224.

During playback of the multimedia content 260 at the display device 224, the user may send a rotatable video frame graphic request 252 to the DVR device 202. In response to the rotatable video frame graphic request 252, the DVR device 202 may send a request 272 to the remote server 240 for frames associated with segments of the multimedia content 260. When the DVR device 202 is a network DVR, the network DVR may request the frames from the remote server 240 or may have the frames stored at the network DVR as part of additional video streams (e.g., rewind/fast-forward streams) that were previously generated based on the multimedia content 260 (e.g., by extracting I-frames from the multimedia content 260 and decreasing the resolution of the extracted I-frames). In response to the request 272 for frames, the remote server 240 may send one or more frames 282 associated with the segments of the multimedia content 260 to the DVR device 202 via a second stream.

In a particular embodiment, the second stream, or a portion thereof, is sent concurrently with the first stream, or a portion thereof. To illustrate, while the first stream is sent to the DVR device 202 to enable playback of a particular recorded program, the second stream may also be sent to the DVR device 202 (e.g., as a second internet protocol (IP) stream), so that the rotatable video frame graphic 230 can be displayed at the display device 224 with minimal or reduced delay. In a particular embodiment, the second stream includes a broadcast stream, a multicast stream, a unicast stream, or any combination thereof. In response to receiving the one or more frames 282 in the second stream, the DVR device 202 may initiate display of the rotatable video frame graphic 230 by sending the rotatable video frame graphic 230 to the display device 224. The received one or more frames 282 may be included in the rotatable video frame graphic 230. In an alternative embodiment, the first stream may be a multicast stream sent from a first server (e.g., a first server of an internet protocol television system) and the second stream may be a unicast stream (e.g., unicast burst) sent from a second server (e.g., a second server of an internet protocol television system).

The rotatable video frame graphic 230 may correspond to the rotatable video frame graphic 130 of FIG. 1 and may include a first position 232, a second position 234, a first representation 236, and a second representation 238. The first representation may correspond to a first frame of the one or more frames 282 and the second representation may correspond to a second frame of the one or more frames 282. The rotatable video frame graphic 230 may operate similarly to the rotatable video frame graphic 130 of FIG. 1.

During playback of the multimedia content 260 and during display of the rotatable video frame graphic 230, a user may issue the navigation control 254 to the DVR device 202 using the remote control device 220. In response to the navigation control 254, the DVR device 202 may send an additional request 272 to the remote server 240 for additional frames associated with additional segments of the multimedia content 260. In response to the additional request 272, the remote server 240 may send one or more additional frames 282 associated with the additional segments of the multimedia content 260 to the DVR device 202 via the second stream (or another stream). The second stream may again be sent concurrently with the first stream. In response to receiving the additional one or more frames 282 in the second stream, the DVR device 202 may update the rotatable video frame graphic 230. As in the illustrative embodiment of FIG. 1, updating the rotatable video frame graphic 230 may include sending an updated graphic to display rotating of ordered frames of the rotatable video frame graphic 230 to make additional frames visible while hiding other frames. The DVR device 202 may generate an updated rotatable video frame graphic 264 and send the updated rotatable video frame graphic 264 to the display device 224. Illustrative embodiments of rotating a video frame graphic are further described with reference to FIGS. 3A-3D.

After the navigation control operation has been completed, the user may select a particular frame displayed at the rotatable video frame graphic to begin playback of a segment associated with the particular frame. For example, the user may use the remote control device 220 to send a segment request 256 to the DVR device 202. The segment request 256 may indicate selection of a particular segment of the multimedia content 260 corresponding to a particular representation displayed at the rotatable video frame graphic 230. In response to the segment request 256, the DVR device 102 may forward the segment request 256 to the remote server 240. In response to the segment request 256, the remote server 240 may send a selected segment 266 to the DVR device 202 to be displayed at the display device 224 via the first stream. In response to receiving the selected segment 266, the DVR device 202 may cease playback of the multimedia content 260 at the display device 224 and may initiate playback of multimedia content 260 starting at the selected segment 266 (e.g., “skip-forward” or “skip-backward” to the selected segment 266) and end display of the rotatable video frame graphic 264 (e.g., after a timeout period). If the selected segment 266 is not a last segment of the multimedia content 260, playback of a next segment occurs after playback of the selected segment 266, and playback continues until the last segment is played.

By receiving the first stream and the second stream concurrently, the system 200 may enable the DVR device 202 to initiate display of the rotatable video frame graphic 230 and to update the rotatable video frame graphic 230 without interrupting playback of the multimedia content 260 received from the remote server 240. For example, when recording a program, the DVR device 202 may store the program as well as a set of frames (e.g., low-resolution I-frames) that can be used to generate the rotatable video frame graphic 230 during playback of the recorded program. Thus, a user may have the convenience of performing seek-forward operations and seek-backward operations without disrupting playback of streamed media content (e.g., internet protocol television broadcast content or video on demand content), without obstructing a large portion of the multimedia content. In alternate embodiments, the DVR device 202 stores the program but may not request frames for the rotatable video frame graphic 230 until playback of the program starts and/or until the rotatable video frame graphic 230 is requested by a user.

In particular embodiments, the rotatable video frame graphics 130, 230 of FIG. 1 and FIG. 2 may be used to perform seek operations with respect to live content and video-on-demand (VOD) content as well as recorded content. For example, a rotatable video frame graphic may be used to rewind and fast-forward VOD content that is received by a set-top box device from a VOD server. As another example, a rotatable video frame graphic may be used to rewind and fast-forward “live” video content that is buffered at a set-top box to simulate trick-play functionalities of rewinding and fast-forwarding live television.

FIGS. 3A-3D show illustrative animation sequences corresponding to seek-forward operations and seek-backward operations. Each animation sequence resembles a rotatable card index that includes many cards with two cards being displayed initially. The numbers on each side of each card correspond to sequential segments within multimedia content. For example, the segment associated with the image labeled number one (1) comes before the segment associated with the image labeled number two (2) within the multimedia content.

Referring to FIG. 3A a first illustrative animation sequence corresponding to a seek-forward operation of a rotatable video frame graphic is shown. In the illustrative animation sequence of FIG. 3A, both sides of each card are associated with a common segment of multimedia content. Initially, an upper card corresponds to a first segment and a lower card corresponds to a second segment. A first transition 302 depicts a rotation of the lower card to reveal part of an additional card corresponding to a third segment. The additional card becomes the lower card and the lower card becomes a rotating card. A second transition 304 depicts the rotating card rotating to cover the upper card. A third transition 306 depicts the rotating card taking the place of the upper card. The animation sequence ends with the upper card corresponding to the second segment and the lower card corresponding to the third segment. As depicted in the animation of FIG. 3A, during a seek-forward operation, each turn of a card reveals one additional segment that is subsequent to the previously displayed segment(s). Thus, as shown in FIG. 3A, updating a rotatable video frame graphic may include animating a rotatable card index to resemble turning a first card of the index to cover a second card of the index and to reveal a third card of the index. In FIG. 3A, both sides of the rotating card may include a representation associated with a single segment (e.g., segment 2). The representation may be in a particular orientation before the card is rotated. After the card is rotated, the representation may be in the same particular orientation on the other side of the rotated card. For example, a frame corresponding to a segment of the multimedia content may be included on a first side of the rotating card in a right-side-up orientation before the card is rotated. After the card is rotated, the frame may be included on a second side of the rotated card in the same right-side-up orientation. Thus, the rotatable video frame graphic the card appears to rotate vertically to a user, the user need not be subjected to confusion associated with an upside-down video frame.

Referring to FIG. 3B a second illustrative animation sequence corresponding to a seek-forward operation of a rotatable video frame graphic is shown. In the illustrative animation sequence of FIG. 3B, each side of each card is associated with a different segment of multimedia content. Initially, a first side of an upper card corresponds to a first segment and a first side of a lower card corresponds to a second segment. Although not shown initially, a second side of the lower card corresponds to a third segment. A first transition 322 depicts a rotation of the lower card to reveal a first side of an additional card corresponding to a fourth segment. The first side of the additional card becomes the lower card and the lower card becomes a rotating card. A second transition 324 depicts the rotating card rotating to cover the first side of the upper card. The rotation reveals the second side of the rotating card corresponding to the third segment. A third transition 326 depicts the second side of the rotating card taking the place of the first side of the upper card. The animation sequence ends with the first side of the upper card corresponding to the third segment and the first side of the lower card corresponding to the fourth segment. As depicted in the animation of FIG. 3B, during a seek-forward operation, each turn of a card reveals two additional segments that are subsequent to the previously displayed segment(s).

Referring to FIG. 3C a first illustrative animation sequence corresponding to a seek-backward operation of a rotatable video frame graphic is shown. In the illustrative animation sequence of FIG. 3C, both sides of each card are associated with a common segment of multimedia content. Initially, an upper card corresponds to a second segment and a lower card corresponds to a third segment. A first transition 342 depicts a rotation of the upper card to reveal part of an additional card corresponding to a first segment. The additional card becomes the upper card and the upper card becomes a rotating card. A second transition 344 depicts the rotating card rotating to cover the lower card. A third transition 346 depicts the rotating card taking the place of the lower card. The animation sequence ends with the upper card corresponding to the first segment and the lower card corresponding to the second segment. As depicted in the animation of FIG. 3C, during a seek-backward operation, each turn of a card reveals one additional segment that precedes the previously displayed segment(s). In FIG. 3C, as with FIG. 3A, both sides of the rotating card may include a representation associated with the segment associated with a single segment (e.g., segment 2). As with FIG. 3A, the representation may be right-side-up before the card is rotated and after the card is rotated.

Referring to FIG. 3D a second illustrative animation sequence corresponding to a seek-backward operation of a rotatable video frame graphic is shown. In the illustrative animation sequence of FIG. 3D, each side of each card is associated with a different segment of multimedia content. Initially, a first side of an upper card corresponds to a third segment and a first side of a lower card corresponds to a fourth segment. Although not shown initially, a second side of the upper card corresponds to a second segment. A first transition 362 depicts a rotation of the upper card to reveal a first side of an additional card corresponding to a first segment. The first side of the additional card becomes the upper card and the upper card becomes a rotating card. A second transition 364 depicts the rotating card rotating to cover the first side of the lower card. The rotation reveals the second side of the rotating card corresponding to the second segment. A third transition 366 depicts the second side of the rotating card taking the place of the first side of the lower card. The animation sequence ends with the first side of the upper card corresponding to the first segment and the first side of the lower card corresponding to the second segment. As depicted in the animation of FIG. 3D, during a seek-backward operation, each turn of a card reveals two additional segments that precede the previously displayed segment(s).

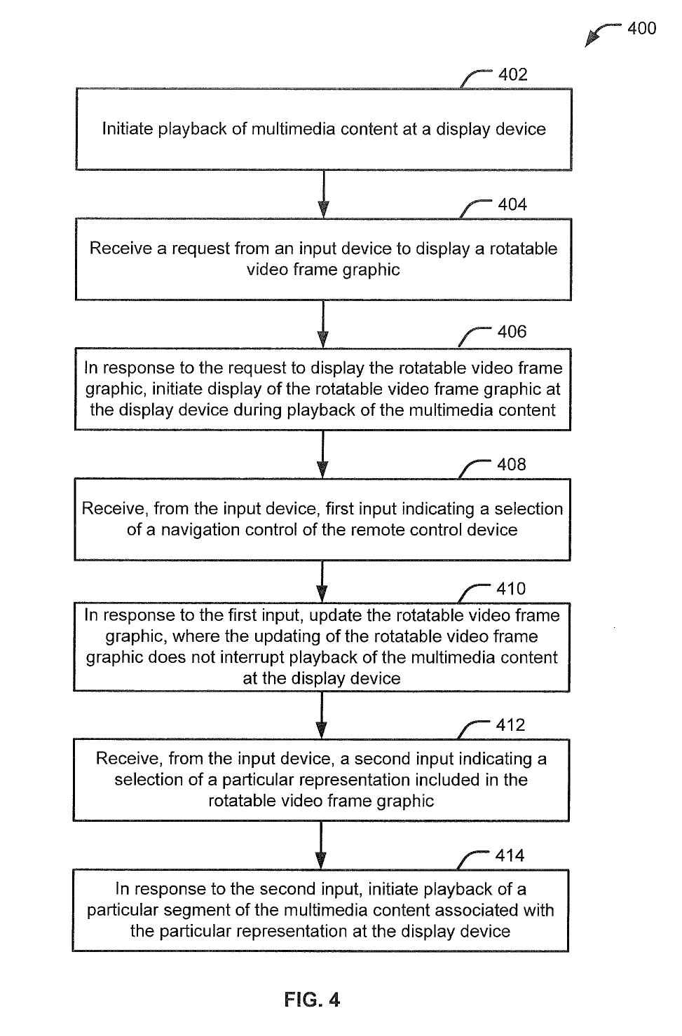

Referring to FIG. 4, a method 400 of controlling a seek position of multimedia content using a rotatable video frame graphic is shown. In an illustrative embodiment, the method 400 may be performed by the DVR device 102 of FIG. 1 or the DVR device 202 of FIG. 2. The method 400 includes initiating playback of multimedia content at a display device, at 402. The method further includes receiving a request from an input device to display a rotatable video frame graphic, at 404. The method also includes, in response to the request to display the rotatable video frame graphic, initiating display of the rotatable video frame graphic at the display device during playback of the multimedia content, at 406. For example, referring to FIG. 1, the DVR device 102 may initiate display of the rotatable video frame graphic 130 at the display device 124 in response to the rotatable video frame request 152 from the remote control device 120.

The method 400 includes receiving, from the input device, first input indicating a selection of a navigation control of the remote control device, at 408. For example, a user may use the remote control device to perform a seek-forward operation, a seek-backward operation, or a pause operation. The method 400 further includes, in response to the first input, updating the rotatable video frame graphic, where the updating of the rotatable video frame graphic does not interrupt playback of the multimedia content at the display device, at 410. For example, referring to FIG. 1, the rotatable video frame graphic 130 may be displayed without covering a large portion of the multimedia content 160 being displayed in a small area of a display (i.e., at the display device 124), and the rotatable video frame graphic 130 may be updated as shown in FIGS. 3A-3D. Thus, the seek-forward operation and the seek-backward operation may be performed concurrently with playback of the multimedia content.

The method 400 also includes receiving, from the input device, a second input indicating a selection of a particular representation included in the rotatable video frame graphic, at 412. The method 400 includes, in response to the second input, initiating playback of a particular segment of the multimedia content associated with the particular representation at the display device, at 414. After playback of the particular segment begins, display of the rotatable video frame graphic may end (e.g., after a timeout period).

In a particular alternative embodiment, the request to display the rotatable video frame graphic, the first input indicating selection of a navigation control, and the second input indicating selection of the particular representation may be initiated by fewer than three inputs from a user. For example, a user may select and hold a seek-forward button or a seek-backward button at the remote control device. As the user holds the seek-forward button or the seek-backward button, the rotatable video frame graphic may be displayed, the rotatable video frame graphic may be updated, and when the seek-forward option or the seek-backward button is released, playback of a particular segment of the multimedia content associated with a visible representation may be initiated. In addition or alternatively, the request to display the rotatable video frame graphic, the first input indicating selection of a navigation control, and the second input indicating selection of the particular representation may be received via a gesture control device (e.g., an infrared or camera-based motion capture device) or a voice control device instead of a handheld remote control device. To illustrate, a gesture that includes a user raising their right arm may be recognized as a request to display a rotatable video frame graphic. A gesture that includes the user moving the arm upwards or downwards may correspond to requests to rotate video frames in the graphic upwards or downwards, respectively. A gesture that includes the user lowering their raised arm may correspond to a request to initiate playback at a selected segment shown by the rotatable video frame graphic. When a voice control device is used, recognized voice commands may include “seek,” “rewind,” “fast-forward,” “skip backwards,” “skip forwards,” “flip back,” “flip forward,” “previous,” “next,” “pause,” “play,” “enter,” “select,” “cancel,” etc. It should also be noted that although various embodiments are described with reference to recorded programming on a DVR device, this is for example only and not to be considered limiting. The described rotatable video frame graphic may also be used to perform seek operations with respect to live content and/or video-on-demand (VOD) content.

The method 400 may thus include initiating display of and updating a rotatable video frame graphic without interrupting playback of multimedia content at a display device, which may enhance an overall experience in performing seek operations at a video playback device, such as a set-top box device, a DVR device, a television, a laptop computer, a desktop computer, a tablet computer, a mobile phone, a game console, etc.

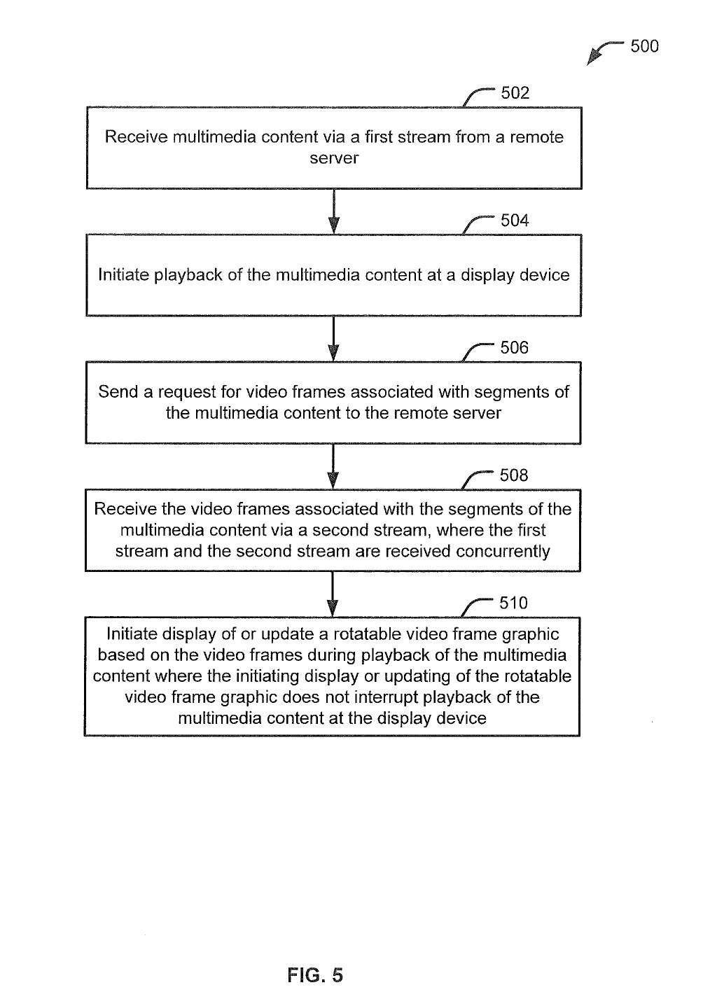

Referring to FIG. 5, a method 500 of controlling a seek position of multimedia content using a rotatable video frame graphic is shown. In an illustrative embodiment, the method 500 may be performed by the DVR device 202 of FIG. 2. The method 500 includes receiving multimedia content via a first stream from a remote server, at 502. The method 500 further includes initiating playback of the multimedia content at a display device, at 504. The method 500 also includes sending a request for video frames associated with segments of the multimedia content to the remote server, at 506. For example, referring to FIG. 2, the video frames 208 may be requested for use with the rotatable video frame graphic 230.

The method 500 includes receiving the video frames associated with the segments of the multimedia content via a second stream, where the first stream and the second stream are received concurrently, at 508. The method 500 further includes initiating display of or updating a rotatable video frame graphic based on the video frames during playback of the multimedia content, where initiating the display or updating the rotatable video frame graphic does not interrupt playback of the multimedia content at the display device, at 510.

Receiving the first stream and the second stream concurrently may enable the rotatable video frame graphic, including the received frames, to be displayed concurrently with the multimedia content without interrupting playback of the multimedia content. The method 500 may thus enable a seek operation to be performed at a system that includes streaming from a remote server (e.g., a video-on-demand delivery system).

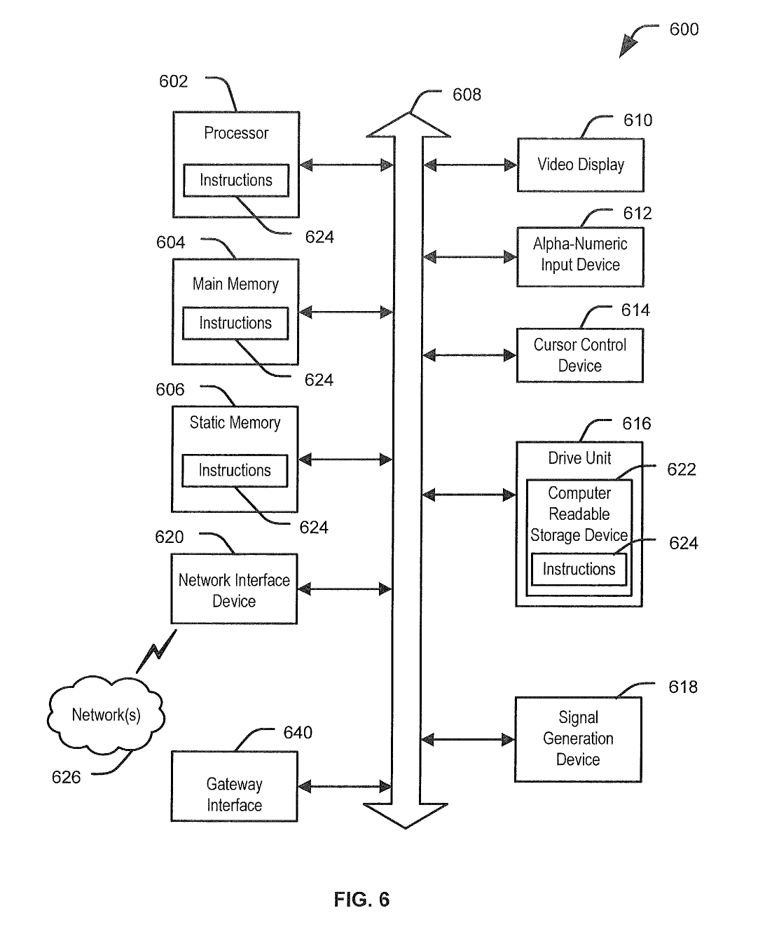

Referring to FIG. 6, an illustrative embodiment of a computer system is shown and designated 600. The computer system 600 can include a set of instructions that can be executed to cause the computer system 600 to perform any of the methods or computer based functions disclosed herein. The computer system 600 may operate as a standalone device or may be connected, e.g., using a network, to other computer systems or peripheral devices. For example, the computer system 600 or portions thereof may implement, include, correspond to or be included within any one or more of the DVR device 102, the DVR device 202, and the remote server 240 illustrated in FIG. 1 and FIG. 2.

In a networked deployment, the computer system 600 may operate in the capacity of a server or as a client user computer in a server-client user network environment, or as a peer computer system in a distributed peer-to-peer or network environment. The computer system 600 can also be implemented as or incorporated into various devices, such as a residential gateway, a wireless gateway, personal computer (PC), a tablet PC, a set-top box (STB), a personal digital assistant (PDA), a mobile device, a palmtop computer, a laptop computer, a desktop computer, a tablet computer, a communications device, a wireless telephone, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video, or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, or a solid state display. Additionally, the computer system 600 may include an input device 612, such as a keyboard, and a cursor control device 614, such as a mouse. In a particular embodiment, the input device 612 and the cursor control device 614 may correspond to a remote control device, such as the remote control device 120 of FIG. 1 or the remote control device 220 of FIG. 2, a gesture control device, a voice control device, or any combination thereof. Such input devices may enable interaction with various GUIs and GUI controls. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable storage device 622 (e.g., a device or an apparatus that stores instructions that when read by a processor, cause the processor to perform operations) in which one or more sets of instructions 624, e.g. software, can be embedded. Further, the instructions 624 may embody one or more of the methods or logic as described herein, such as the methods or operations described with reference to FIGS. 1-5. In a particular embodiment, the instructions 624 may reside completely, or at least partially, within the main memory 604, the static memory 606, and/or within the processor 602 during execution by the computer system 600. The main memory 604 and the processor 602 also may include computer-readable media (e.g., a computer-readable storage device or apparatus). In a particular embodiment, the computer-readable storage device 622 may store instructions 624 that are executable to perform one or more operations described with reference to the DVR device 100 of FIG. 1, the DVR device 200 of FIG. 2, and/or the remote server 240 of FIG. 2. Further, the computer-readable storage device 622 may store instructions 624 operable to control a seek position of multimedia content using a rotatable video frame graphic as described with reference to FIG. 4 and FIG. 5.

In a particular embodiment, the system 600 includes a gateway interface 640. The gateway interface 640 may enable the system 600 to communicate with one or more gateways (e.g., the wireless gateway 104) and to receive data from one or more devices coupled to the one or more gateways as described with reference to FIG. 1. In another particular embodiment, the system 600 may communicate with a gateway (e.g., the wireless gateway 104) via the network interface device 620.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable device 622 that includes instructions 624 so that a device connected to a network 626 can communicate voice, video or data over the network 626. Further, the instructions 624 may be transmitted or received over the network 626 via the network interface device 620.

While the computer-readable device is shown to be a single device, the term “computer-readable device” includes a single device or multiple devices, such as a centralized or distributed database, and/or associated caches and servers that store one or more sets of instructions. The term “computer-readable device” shall include any device that is capable of storing or encoding a set of instructions for execution by a processor or that cause a computer system to perform any one or more of the methods or operations disclosed herein. Thus, a “computer-readable device” is an article of manufacture and is not a signal.

In a particular non-limiting, exemplary embodiment, the computer-readable device can include a solid-state memory such as a memory card or other package that houses one or more non-volatile read-only memories. Further, the computer-readable device can be a random access memory or other volatile re-writable memory. Additionally, the computer-readable device can include a magneto-optical or optical device, such as a disk or tapes or other storage device. Accordingly, the disclosure is considered to include any one or more of a computer-readable device and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for communication include TCP/IP, UDP/IP, HTML, HTTP, and 802.11x. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the disclosure. Thus, to the maximum extent allowed by law, the scope of the disclosure is to be determined by the broadest permissible interpretation of the following claims and their equivalents, and shall not be restricted or limited by the foregoing detailed description.

What is claimed is:

1. A method comprising:
at an electronic device:
initiating display of a rotatable video frame graphic at a display device, wherein the rotatable video frame graphic enables a user to seek particular frames of multimedia content, wherein the rotatable video frame graphic includes a first representation associated with a first segment of the multimedia content and a second representation associated with a second segment of the multimedia content, wherein the first representation is displayed in a first position and the second representation is displayed in a second position, and wherein the first position and the second position are arranged vertically with one position above the other position;
receiving, from an input device, a first input indicating a selection of a navigation control; and
in response to the first input, updating the rotatable video frame graphic to:
include a third representation associated with a third segment of the multimedia content; and
remove the first representation from the rotatable video frame graphic.

2. The method of claim 1, further comprising updating the video frame graphic to replace the first representation at the first position with the second representation and to display the third representation in the second position.

3. The method of claim 2, wherein the rotatable video frame graphic includes a depiction of a rotatable card index, wherein the first representation corresponds to a first card, wherein the second representation corresponds to a second card, wherein the third representation corresponds to a third card, wherein updating the video frame graphic comprises animating the rotatable card index to resemble turning the second card of the rotatable card index to cover the first card and to reveal the third card.

4. The method of claim 1, further comprising updating the video frame graphic to remove the second representation and to include a fourth representation associated with a fourth segment of the multimedia content, wherein the third representation is displayed in the first position, and wherein the fourth representation is displayed in the second position.

5. The method of claim 4, wherein the rotatable video frame graphic includes a depiction of a rotatable card index, wherein the first representation corresponds to a first side of a first card, wherein the second representation corresponds to a first side of a second card, wherein the third representation corresponds to a second side of the second card, wherein the fourth representation corresponds to a first side of a third card, and wherein updating the video frame graphic comprises animating the rotatable card index to resemble turning the second card of the rotatable card index to cover the first card and to reveal the third card.

6. The method of claim 1, wherein the first position is vertically above the second position within the rotatable video frame graphic, wherein the second segment is subsequent to the first segment, and wherein the navigation control corresponds to a seek-forward command.

7. The method of claim 1, wherein the first position is vertically below the second position within the rotatable video frame graphic, wherein the first segment is subsequent to the second segment, and wherein the navigation control corresponds to a seek-backward command.

8. The method of claim 1, further comprising receiving a request from the input device to display the rotatable video frame graphic, wherein the initiating of the display of the rotatable video frame graphic is in response to the request.

9. The method of claim 1, further comprising initiating playback of the multimedia content at the display device, wherein display of the rotatable video frame graphic occurs during playback of the multimedia content, and wherein the updating of the rotatable video frame graphic does not interrupt playback of the multimedia content at the display device.

10. The method of claim 1, further comprising:
receiving, from the input device, a second input indicating a selection of a particular representation included in the rotatable video frame graphic, wherein the particular representation is associated with a particular segment of the multimedia content; and
in response to the second input, initiating playback of the particular segment of the multimedia content at the display device.

11. The method of claim 1, wherein the first representation corresponds to a first frame associated with the first segment, wherein the second representation corresponds to a second frame associated with the second segment, and wherein the third representation corresponds to a third frame associated with the third segment.

12. The method of claim 11, further comprising receiving the multimedia content via a first stream from a remote server, and receiving the first frame, the second frame, and the third frame via a second stream from the remote server, wherein the first stream and the second stream are received concurrently.

13. The method of claim 12, wherein the first stream is received via multicast, and wherein the second stream is received via a unicast burst.

14. The method of claim 1, wherein the multimedia content is stored at the electronic device, the multimedia content is received at the electronic device via a network, the representations of the segments of the multimedia content are received via the network, or any combination thereof.

15. The method of claim 1, wherein the input device includes a remote control device, a gesture control device, a voice control device, or any combination thereof.

16. An apparatus comprising:
a processor; and
a memory comprising instructions that, when executed by the processor, cause the processor to perform operations comprising:
initiating display of a rotatable video frame graphic at a display device, wherein the rotatable video frame graphic enables a user to seek particular frames of multimedia content, wherein the rotatable video frame graphic includes a first representation associated with a first segment of the multimedia content and a second representation associated with a second segment of the multimedia content, wherein the first representation is displayed in a first position and the second representation is displayed in a second position, and wherein the first position and the second position are arranged vertically with one position above the other position;
receiving, from an input device, a first input indicating a selection of a navigation control; and
in response to the first input, updating the rotatable video frame graphic to:
include a third representation associated with a third segment of the multimedia content; and
remove the first representation from the rotatable video frame graphic.

17. The apparatus of claim 16, wherein the rotatable video frame graphic includes a depiction of a rotatable card index, wherein the first representation corresponds to a first card, wherein the second representation corresponds to a second card, wherein the third representation corresponds to a third card, wherein updating the video frame graphic comprises animating the rotatable card index to resemble turning the second card of the rotatable card index from the second position to the first position to cover the first card and to reveal the third card, wherein the third card is in the second position.

18. The apparatus of claim 16, wherein the rotatable video frame graphic includes a depiction of a rotatable card index, wherein the first representation corresponds to a first side of a first card, wherein the second representation corresponds to a first side of a second card, wherein the third representation corresponds to a second side of the second card, wherein a fourth representation associated with a fourth segment of the multimedia content corresponds to a first side of a third card, and wherein updating the video frame graphic comprises animating the rotatable card index to resemble turning the second card of the rotatable card index to cover the first side of the first card and the first side of the second card and to reveal the second side of the second card and the first side of the third card.

19. A computer readable storage device storing instructions that, when executed by a processor, cause the processor to perform operations comprising:
initiating display of a rotatable video frame graphic at a display device, wherein the rotatable video frame graphic enables a user to seek particular frames of multimedia content, wherein the rotatable video frame graphic includes a first representation associated with a first segment of the multimedia content and a second representation associated with a second segment of the multimedia content, wherein the first representation is displayed in a first position and the second representation is displayed in a second position, and wherein the first position and the second position are arranged vertically with one position above the other position;
receiving, from an input device, a first input indicating a selection of a navigation control; and
in response to the first input, updating the rotatable video frame graphic to:
include a third representation associated with a third segment of the multimedia content; and
remove the first representation from the rotatable video frame graphic.

20. The computer readable storage device of claim 19, wherein the input device includes a remote control device, a gesture control device, a voice control device, or any combination thereof.
